(19) United States
(12) Patent Application Publication
(10) Pub. No.: US 2021/0191323 A1
(43) Pub. Date: Jun. 24, 2021

(54) Rotor for automatic wristwatch and fabrication method for the same

(71) Applicant: HMDC Corp., Seoul (KR)

(72) Inventor: Young Soo KIM, Seoul (KR)

(21) Appl. No.: 16/726,259

(22) Filed: Dec. 24, 2019

(30) Foreign Application Priority Data
Dec. 18, 2019 (KR) 10-2019-0170158

(51) Int. Cl. G04B 5/16; G04D 3/00

(52) U.S. Cl. CPC G04B 5/16; G04D 3/0069

(57) ABSTRACT

A rotor for an automatic wristwatch is disclosed. A rotor for an automatic wristwatch according to an embodiment of the present invention includes: a coupling opening configured to be coupled to a rotation shaft of a spring; a body configured to form an area of about a semicircle with the coupling opening as a rotation axis; and a mother-of-pearl part configured to be coupled to the body, wherein the mother-of-pearl part may be accurately engaged with and seated on a seating portion formed on one surface of the body to form a complex shape with one surface of the body.

### CROSS-REFERENCE TO RELATED APPLICATION

This application claims priority to and the benefit of Korean Patent Application No. 10-2019-0170158 filed in the Korean Intellectual Property Office on Dec. 18, 2019, the entire contents of which are incorporated herein by reference.

### BACKGROUND OF THE INVENTION

### (a) Field of the Invention

The present invention relates to a rotor for an automatic wristwatch and fabrication method for the same.

### (b) Description of the Related Art

A wristwatch, depending on a power source thereof, can be classified into a quartz wristwatch using a battery as a power source and a mechanical wristwatch operated by winding and releasing a spring without a battery.

The mechanical wristwatch may be classified into a hand-winding type wristwatch that has to wind a spring directly by hand and an automatic or self-winding wristwatch in which a spring is automatically wound as a wearer moves.

The automatic wristwatch includes a part called a rotor. The rotor is designed to rotate by gravity when the wearer's wrist moves. This rotational movement is transmitted to the spring, and thus, the spring may be automatically wound.

Meanwhile, in the automatic wristwatch, a cover of an area in which the rotor is installed may be transparent so that the wearer may directly observe the movement of the rotor. Therefore, the rotor has been an object of a manufacturer's unique design.

The rotor is mostly made of metal. Most of parts included in the wristwatch are made of metal, and precision metalworking technology has been developed. A shape of the rotor made as described above may be changed to some extent, but there are technical difficulties in expressing a shape including various color changes.

Particularly, in order to apply mother-of-pearl, which is widely used in precious metals, to parts of the wristwatch, a technology that is substantially comparable to the precision of metal processing is required.

The above information disclosed in this Background section is only for enhancement of understanding of the background of the invention, and therefore it may contain information that does not form the prior art that is already known in this country to a person of ordinary skill in the art.

### SUMMARY OF THE INVENTION

An exemplary embodiment of the present invention provides a rotor for an automatic wristwatch that may realize a design change of various shapes by accurately engaging a metal and mother-of-pearl, a manufacturing method thereof, and a wristwatch that is provided with the same rotor to be able to appreciate the design of the rotor.

An embodiment of the present invention provides a rotor for an automatic wristwatch including: a coupling opening configured to be coupled to a rotation shaft of a spring; a body configured to form an area of about a semicircle with the coupling opening as a rotation axis; and a mother-of-pearl part configured to be coupled to the body, wherein the mother-of-pearl part may be accurately engaged with and seated on a seating portion formed on one surface of the body to form a complex shape with one surface of the body.

The mother-of-pearl part may be manufactured by preparing a mother-of-pearl shell; applying a water-soluble photosensitive agent to the mother-of-pearl shell; placing a film formed with a through hole corresponding to the seating portion on a light irradiation path to irradiate light toward the mother-of-pearl shell to form an insoluble portion having a shape of the through-hole in the mother-of-pearl shell; water-treating the mother-of-pearl shell to eliminate the water-soluble photosensitive agent except the insoluble portion; and applying a hydrochloric acid to the mother-of-pearl shell to eliminate portions except the insoluble portion, and a size of the mother-of-pearl part may be accurately matched with that of the seating portion such that the mother-of-pearl part may be tightly engaged with and coupled to the seating portion.

Another embodiment of the present invention provides a manufacturing method of a rotor for an automatic wristwatch that includes a seating portion engaged with and coupled to a mother-of-pearl part, including: preparing a mother-of-pearl shell; applying a water-soluble photosensitive agent to the mother-of-pearl shell; placing a film formed with a through hole corresponding to the seating portion on a light irradiation path to irradiate light toward the mother-of-pearl shell to form an insoluble portion having a shape of the through-hole in the mother-of-pearl shell; water-treating the mother-of-pearl shell to eliminate the water-soluble photosensitive agent except the insoluble portion; applying a hydrochloric acid to the mother-of-pearl shell to eliminate portions except the insoluble portion such that a contour of the mother-of-pearl part is formed; and coupling the mother-of-pearl part to the seating portion.

Another embodiment of the present invention provides a wristwatch provided with a rotor for an automatic wristwatch, including: the rotor; a movement including a spring automatically wound by the rotor; and a housing accommodating the rotor and the movement, wherein the housing may include a transparent portion formed at a rear side thereof so that the rotor is viewed from the outside.

According to the embodiment of the present invention, in a design of a rotor for an automatic wristwatch, it is possible to implement a variety of beautiful shapes of a metal and mother-of-pearl bing engaged by accurately engaging the metal and the mother-of-pearl.

### BRIEF DESCRIPTION OF THE DRAWINGS

FIG. 1 illustrates a rotor for an automatic wristwatch according to an embodiment of the present invention.

FIG. 2 illustrates a manufacturing method of a rotor for an automatic wristwatch according to an embodiment of the present invention.

FIG. 3 illustrates a process of forming components of a rotor according to a manufacturing method of the rotor for an automatic wristwatch according to an embodiment of the present invention.

FIG. 4 illustrates a wristwatch provided with a rotor for an automatic wristwatch according to an embodiment of the present invention.

### DETAILED DESCRIPTION OF THE EMBODIMENTS

The present invention may be modified in various ways and may have several embodiments. Specific embodiments of the present invention are illustrated in the drawings and described in detail in the detailed description. However, the present invention is not intended to be limited to the specific embodiments, and it should be understood that the present invention includes all modifications, equivalents, or substitutions which fall within the spirit and technical scope of the present invention.

In describing the embodiments of the present invention, a detailed description of pertinent known features will be omitted if it is deemed to make the gist of the present invention unnecessarily vague.

Hereinafter, an embodiment of the present invention will be described in detail with reference to the accompanying drawings.

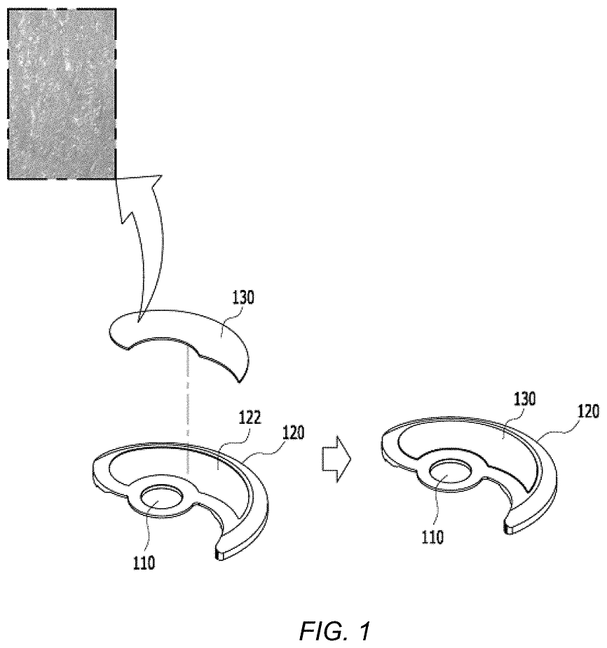

FIG. 1 illustrates a rotor 100 for an automatic wristwatch according to an embodiment of the present invention.

Referring to FIG. 1, the rotor 100 for the automatic wristwatch according to the embodiment of the present invention includes a coupling opening 110, a body 120, and a mother-of-pearl part 130.

The coupling opening 110 is a circular small hole formed around a rotation axis of the rotor 100 for the automatic wristwatch.

The coupling opening 110 is an element to be coupled to a spring (not shown), and it may transmit rotational force to the spring through a coupling portion.

The body 120 may form an area of about a semicircle based on the coupling opening 110 as a rotation axis. Here, the formed area of about the semicircle may mean an area formed to have an angle and a shape that do not exactly occupy the semicircle but do not deviate too much from the semicircle.

This degree of freedom allows design changes. The body 120 according to the embodiment of the present invention may be formed to have a shape associating, for example, a taeguk (or taiji) pattern as shown in FIG. 1.

A lower surface of the body 120 is designed not to spatially collide with a movement (or movement part), and it may be manufactured by deforming corresponding to a structure of the movement.

An upper surface of the body 120 may have a seating portion 122 formed a predetermined shape to be deeper than a periphery thereof. The predetermined shape means a shape corresponding to the mother-of-pearl part 130 to be coupled to the seating portion 122, and it may be a design consideration.

Since the body 120 is provided with the seating portion 122 formed on the upper surface thereof, it may provide a space in which the mother of pearl part 130 may be engaged therewith.

The body 120 may be made of a metal material, and may be precisely processed.

The mother-of-pearl part 130 is made of a mother-of-pearl material, and the mother-of-pearl, which is a small piece obtained from a clamshell, has a characteristic of showing a variety of colors locally on a delicate background of the white series.

Typical mother-of-pearl has been used to decorate furniture, etc., through a process such as powdering, to play a role of expressing luxury.

The mother-of-pearl part 130 may be accurately seated engaged with the seating portion 122 formed on one surface of the body 120.

The mother-of-pearl part 130 may be accurately seated engaged with the seating portion 122 to form a complex shape with one surface of the body 120. This may widen the changes in the design of the rotor 100 for the automatic wristwatch, which was conventionally made only of a metal material, and simultaneously, may provide a luxurious sense of seeing.

Conventionally, the mother-of-pearl was technically difficult to be used in precision parts such as those of the wristwatch. The reason for this is as follows. Metal parts used in the movement of the watch are manufactured by a precisely machined work, while the mother-of-pearl is not as hard as metal, thus it is difficult to apply mechanical machining to the mother-of-pearl. The mother-of-pearl processed by hand using a jigsaw instead of the mechanical machining had difficulty when it is engaged with precise metal parts due to difficulty in precise dimensional management.

However, since the mother-of-pearl manufactured by the manufacturing method of the present invention is managed by a method using a photolithography etching method used in a semiconductor manufacturing process, its precise dimension management is possible.

For this purpose, in an embodiment of the present invention, the mother-of-pearl part 130 may be manufactured by preparing a mother-of-pearl shell 310; applying a water-soluble photosensitive agent to the mother-of-pearl shell 310; placing a film 320 formed with a through hole corresponding to the seating portion 122 on a light irradiation path to irradiate light toward the mother-of-pearl shell 310 to form an insoluble portion 310-2 having a shape of the through-hole in the mother-of-pearl shell 310; water-treating the mother-of-pearl shell 310 to eliminate the water-soluble photosensitive agent except the insoluble portion 310-2; and applying a hydrochloric acid to the mother-of-pearl shell 310 to eliminate portions except the insoluble portion 310-2.

A size of the manufactured mother-of-pearl part 130 is accurately matched with that of the seating portion 122, so that the mother-of-pearl part 130 may be tightly engaged with and coupled to the seating portion 122.

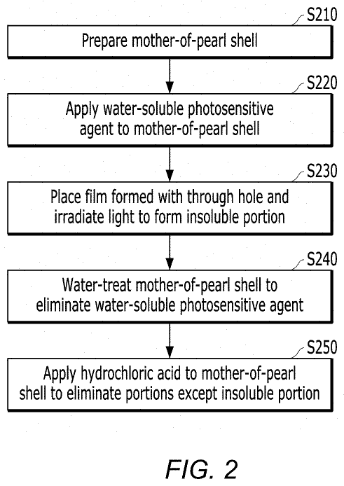

FIG. 2 illustrates a manufacturing method of the rotor 100 for the automatic wristwatch according to the embodiment of the present invention.

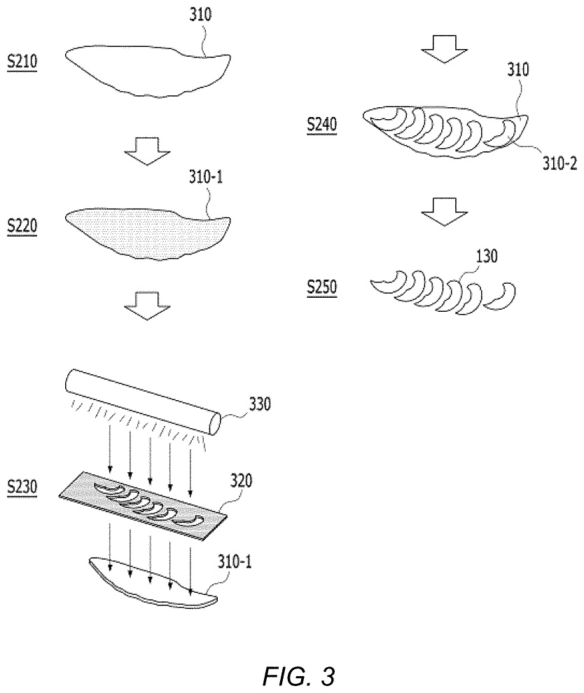

FIG. 3 illustrates a process of forming components of the rotor 100 for the automatic wristwatch according to the manufacturing method of the rotor for the automatic wristwatch according to the embodiment of the present invention.

The manufacturing method of the rotor 100 for the automatic wristwatch will be described with referring to FIG. 2 and FIG. 3.

At step S210, the mother-of-pearl shell 310 may be prepared.

The mother-of-pearl shell 310 may be a piece separated from a shell of a calcium (Ca) component. Specifically, the mother-of-pearl shell 310 may be composed of a thin plate-like piece processed by thinly cutting a shell (or clamshell) like paper.

The mother-of-pearl shell 310 serves as a raw material to be carved as the mother-of-pearl part 130, which is a component of the rotor 100 for the automatic wristwatch.

At step S220, a water-soluble photosensitive agent is applied to the mother-of-pearl shell 310.

The water-soluble photosensitive agent has properties that may be dissolved in water, and when light of a specific wavelength is irradiated thereon, it has a characteristic in which a portion thereof that reacts to the light is insoluble.

At step S230, by irradiating light by a driven light source 330 toward the mother-of-pearl shell 310, to which the water-soluble photosensitive agent is applied, after placing the film 320 that is formed with a through hole corresponding to the seating portion 122 on a light irradiation path, the insoluble portion 310-2 having a shape of the through-hole is formed in the mother-of-pearl shell 310.

The film 320 may include a document film for general screen printing.

As the light source 330, a halogen lamp having an output of about 300 W may be used.

By the above-mentioned process, the water-soluble photosensitive agent becomes insoluble by reacting with light. The insoluble portion 310-2, which corresponds to an area that becomes insoluble, may exactly match a shape corresponding to the seating portion 122.

At step S240, the mother-of-pearl shell 310 in which the water-soluble photosensitive agent and the insoluble portion 310-2 coexist is water-treated such that the water-soluble photosensitive agent except the insoluble portion 310-2 may be eliminated.

The water soluble photosensitive agent is easily dissolved in water to be separated from the mother-of-pearl shell 310, thus only the insoluble portion 310-2 for forming the mother-of-pearl part 130 remains.

At step S250, by applying hydrochloric acid to the mother-of-pearl shell 310 in which only the insoluble portion 310-2 remains, portions except the insoluble portion 310-2 are eliminated to form a contour of the mother-of-pearl part 130.

At step S250, the portions except the insoluble portion 310-2 may be eliminated by the hydrochloric acid, and only the insoluble portion 310-2 remains to accurately form the contour of the mother-of-pearl part 130 as intended.

The mother-of-pearl part 130 formed as described above may be accurately engaged with and coupled to the seating portion 122 of the rotor 100 for the automatic wristwatch.

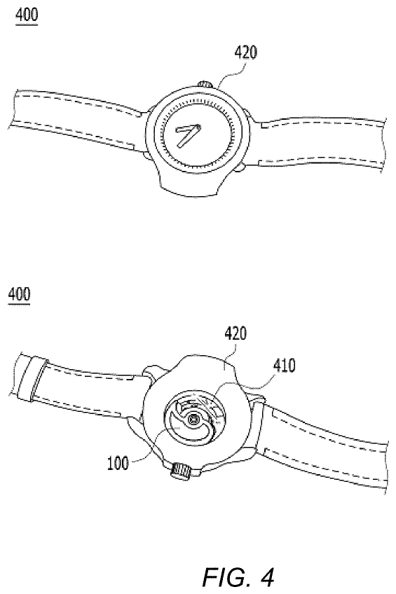

FIG. 4 illustrates a wristwatch 400 provided with the rotor for the automatic wristwatch according to the embodiment of the present invention.

Referring to FIG. 4, the wristwatch 400 provided with the rotor for the automatic wristwatch includes the rotor 100, a movement 410, and a housing 420.

The rotor 100, which is a component of the wristwatch 400 provided with the automatic wristwatch may be the same as the above-described rotor 100 for the automatic watch.

The movement 410 means a set of parts for driving the wristwatch 400 provided with the rotor for the automatic watch, which is composed of a spring wound by the rotor 100 and various gears driven by the spring being unwound.

The housing 420 accommodates the rotor 100 and the movement 410 to protect these dynamic components from external impacts.

A front surface of the housing 420 is configured to be most transparent so that the hour, minute, and second hands may be viewed.

A transparent portion 422 may be formed in at least a portion of a rear surface of the housing 420. The rotor 100 may be visible to the outside through the transparent portion 422.

The rotor 100 according to the present invention may be variously design-changed, and particularly, since the wristwatch 400 provided with the rotor for the automatic wristwatch may be viewed from the outside through the transparent portion 422, an excellent product design is possible.

The terms used in the specification are used to describe only specific embodiments and are not intended to limit the scope of the present invention. In the present application, it should be understood that the term “include”, “comprise”, “have”, or “configure” indicates that a feature, a number, a step, an operation, a component, a part, or a combination thereof described in the specification is present, but does not exclude a possibility of presence or addition of one or more other features, numbers, steps, operations, components, parts, or combinations, in advance.

### DESCRIPTION OF SYMBOLS

100: rotor
110: coupling opening
120: body
122: seating portion
130: mother-of-pearl part
200: wristwatch
310: mother-of-pearl shell
310-1: mother-of-pearl shell to which water soluble photoresistive agent is applied
310-2: insoluble portion
320: film
330: light source
400: wristwatch
410: movement
420: housing
422: transparent portion

1. A rotor for an automatic wristwatch, comprising:
a coupling opening configured to be coupled to a rotation shaft of a spring;
a body configured to form an area of about a semicircle with the coupling opening as a rotation axis; and
a mother-of-pearl part configured to be coupled to the body,
wherein the mother-of-pearl part is accurately engaged with and seated on a seating portion formed on one surface of the body to form a complex shape with one surface of the body.

2. The rotor for the automatic wristwatch of claim 1, wherein
the mother-of-pearl part is manufactured by preparing a mother-of-pearl shell; applying a water-soluble photosensitive agent to the mother-of-pearl shell; placing a film formed with a through hole corresponding to the seating portion on a light irradiation path to irradiate light toward the mother-of-pearl shell to form an insoluble portion having a shape of the through-hole in the mother-of-pearl shell; water-treating the mother-of-pearl shell to eliminate the water-soluble photosensitive agent except the insoluble portion; and applying a hydrochloric acid to the mother-of-pearl shell to eliminate portions except the insoluble portion, and
a size of the mother-of-pearl part is accurately matched with that of the seating portion such that the mother-of-pearl part is able to be tightly engaged with and coupled to the seating portion.

3. A manufacturing method of a rotor for an automatic wristwatch that includes a seating portion engaged with and coupled to a mother-of-pearl part, comprising:
preparing a mother-of-pearl shell;
applying a water-soluble photosensitive agent to the mother-of-pearl shell;
placing a film formed with a through hole corresponding to the seating portion on a light irradiation path and irradiate light toward the mother-of-pearl shell to form an insoluble portion having a shape of the through-hole in the mother-of-pearl shell;
water-treating the mother-of-pearl shell to eliminate the water-soluble photosensitive agent except the insoluble portion;
applying a hydrochloric acid to the mother-of-pearl shell to eliminate portions except the insoluble portion such that a contour of the mother-of-pearl part is formed; and
coupling the mother-of-pearl part to the seating portion.

4. A wristwatch provided with a rotor for an automatic wristwatch, comprising:
the rotor of claim 1;
a movement including a spring automatically wound by the rotor; and
a housing accommodating the rotor and the movement,
wherein the housing includes a transparent portion formed at a rear side thereof so that the rotor is viewed from the outside.

5. A wristwatch provided with a rotor for an automatic wristwatch, comprising:
the rotor of claim 2;
a movement including a spring automatically wound by the rotor; and
a housing accommodating the rotor and the movement,
wherein the housing includes a transparent portion formed at a rear side thereof so that the rotor is viewed from the outside.
